(19) United States
(12) Patent Application Publication
(10) Pub. No.: US 2006/0243647 A1
(43) Pub. Date: Nov. 2, 2006

(54) Apparatus for providing demineralized water

(75) Inventor: Charles W. Mitsis, Scottsdale, AZ (US)

Correspondence Address: Kevin B. Jackson, Esq., 8220 N. Charles Drive, Paradise Valley, AZ, 85253, US

(73) Assignee: SpectraPure

(21) Appl. No.: 11/118,176

(22) Filed: Apr. 29, 2005

(51) Int. Cl. B01D 17/12

(52) U.S. Cl. 210/96.1; 210/257.1; 210/202; 210/259; 210/101

(57) ABSTRACT

In one embodiment, an apparatus for controlling conductivity of a water stream includes a filtration unit, a purification unit, and a storage vessel. A source of water is filtered and portion is then demineralized. A controlled portion of the filtered water is mixed with the demineralized water to increase its conductivity. In a further embodiment, the apparatus is coupled to an electrode steam generator.

### FIELD OF THE INVENTION

This invention relates in general to water purification apparatus, and more particularly to an apparatus for controlling the concentration of inorganic impurities in water streams to desired levels.

### BACKGROUND OF THE INVENTION

Many types of systems exist that require purified or demineralized water to carry out specific processes. For example, steam producing humidifiers are utilized in many buildings to maintain humidity at desired levels. Electrode steam generators are one type of apparatus used in steam producing humidifiers.

An electrode steam generator or ESG system typically comprises a vessel filled with water and at least two electrodes for passing an electric current through the water. The vessel is made of a material that is resistant to the steam and hot water, and typically is made of a plastic material. The electrodes are immersed in the water, and alternating current is supplied to the electrodes. The current travels through the water to produce heat, which then boils the water. For a given voltage, the amount of current determines the amount of steam produced.

A major problem associated with ESG systems is scaling formation on the electrodes, vessel and other parts. Scaling is a result of the continuous boiling of water, which leaves an increasing mineral accumulation or concentration within the water remaining in the vessel. These mineral accumulations increase the conductivity of the water, and thus the amount of current flowing. However, the mineral accumulation also results in scale formation on the electrodes, which acts as an insulating layer. This decreases the efficiency of the ESG. Scaling also promotes corrosion of the electrodes because they typically comprise a ferrous material. Thus, scaling is both a detriment to operational efficiency and reliability, and affects cost of ownership because of increased costs associated with replacing vessels, electrodes, and other system components.

One approach used to reduce scaling in ESG systems requires that water be purged from the vessel at regular intervals, and replaced with fresh water. Another approach involves using water having a low mineral content. However, such approaches have been difficult to implement for a variety of technical reasons.

For example, purging the water does not remove mineral deposits already formed on the vessel, electrode, or other system components. Also, the deposits already formed may separate and accumulate on a mesh or screen filter typically placed at the bottom of the vessel. This clogs or blocks the purging process, and accelerates the rate of deposition because the purging process is ineffective. Eventually, the system becomes completely clogged rendering it inoperable. As a result, some vessels have partially melted due to arcing from excessive deposit formation, while others have caught fire or exploded. This presents obvious safety concerns.

In some locations, water is available having a low mineral or charged inorganic content. However, in most cities this is not the case. Thus, most water sources contain significant amounts of sparingly soluble salts that will precipitate out of solution causing excessive scale build-ups in systems that utilize such water sources. Examples of sparingly soluble salts include compounds such as barium or strontium sulphates. Furthermore, most water sources in North America range in the medium to hard level, where medium hardness is about one-hundred seventy parts per million of minerals, and where hard is about six-hundred parts per million. Hardness is commonly caused by calcium and magnesium carbonates, sulphates, bicarbonates, and minerals such as silica.

Common techniques used to reduce mineral or charged inorganic content in water used in systems such as ESG systems include filtration, distillation and purification. However, users have found that filtration generally is ineffective in removing minerals in solution, distillation is prohibitively expensive, and traditional purification reduces operation efficiency and reliability because the water produced has poor conductivity and, in certain cases is corrosive.

Accordingly, a need exists for apparatus that controls the concentration of minerals and/or other impurities in water streams to desired levels.

### BRIEF DESCRIPTION OF THE DRAWINGS

FIG. 1 is a schematic view of an apparatus for providing a demineralized water stream in accordance with a first embodiment of the present invention;

FIG. 2 is a schematic view of an apparatus for providing a demineralized water stream in accordance with another embodiment of the present invention;

FIG. 3 is a schematic view of an apparatus for providing a demineralized water stream in accordance with a further embodiment of the present invention; and

FIG. 4 is a schematic view of an apparatus for providing a demineralized water stream in accordance with a still further embodiment of the present invention.

### DETAILED DESCRIPTION OF THE DRAWINGS

In the figures, elements having the same reference number have similar functionality. For simplicity and clarity of illustration, the drawing figures illustrate the general manner of construction, and descriptions and details of well-known features, components and techniques are omitted to avoid unnecessarily obscuring the invention. Additionally, elements in the drawing figures are not necessarily drawn to scale, and the same reference numerals in the different figures typically denote the same elements throughout.

Also, the terms first, second, third, fourth, and the like in the description and in the claims, if any, are used for distinguishing between similar elements and not necessarily for describing a sequential or chronological order. It is further understood that the terms so used are interchangeable under appropriate circumstances and that the embodiments of the invention described herein are capable of operation in other sequences than described or illustrated herein.

In two the following embodiments, the present invention is described coupled to an electrode steam generator embodiment as an example. However, as those skilled in the art will understand, the present invention is suitable for other systems where optimized characteristics (e.g., conductivity, resistivity, etc.) of a water source are relevant.

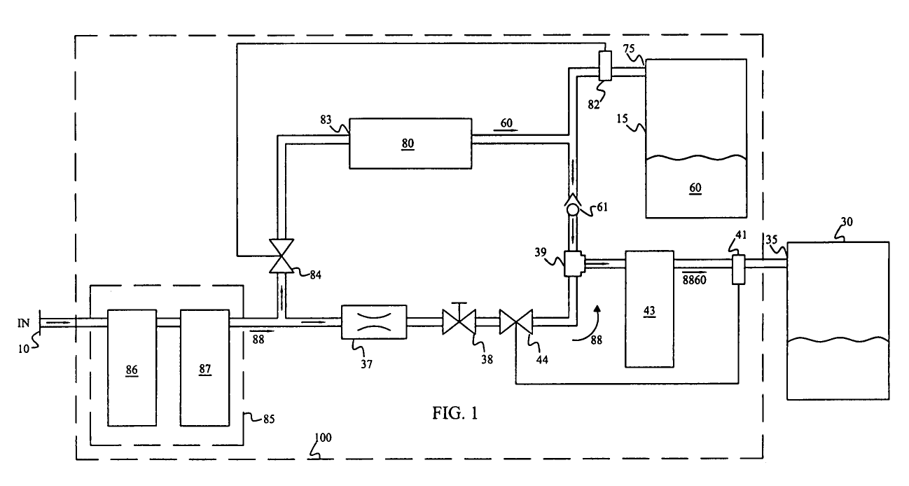

FIG. 1 is a schematic view of a first embodiment of an apparatus or device 100 for controlling or optimizing the concentration of minerals or inorganic impurities in a water source 10 in accordance with the present invention. In this embodiment, apparatus 100 controls or adjusts the conductivity of water source 10 to a desired level. By way of example, the output of apparatus 100 is coupled to an electrode steam generator or ESG system 30. Device 100 includes a inorganic impurity removing device, a demineralization device, a water demineralization system, or a purification system 80, which supplies a source of demineralized water 60 to a tank or storage vessel 15. Purification system 80 comprises, for example, a reverse osmosis (R.O.) purification system, a deionizing (D.I.) purification system, combinations thereof, or the like.

R.O. purification and D.I. purification processes typically remove scale producing substances like calcium, magnesium carbonates, bicarbonates and silica to less than about twenty parts per million, and in the process also significantly reduce the conductivity of demineralized water 60 to less than one-hundred micro-siemens/cm. In general, ESG systems require water having a conductivity of at least about 100 micro-siemens/cm in order to operate.

In one embodiment, tank 15 includes a pressure bladder tank having a connection port 75 for filling or removing demineralized water 60. Tank 15 holds a desired quantity of demineralized water 60 suitable for the requirements of ESG system 30 or other systems apparatus 100 is connected to. In an alternate embodiment where space and/or costs constraints are an issue tank 15 is not used if purification system 80 has sufficient output volume to meet the demand conditions of the system it is connected to. Connection port 75 is coupled to an input 35 of ESG 30. In one embodiment, port 75 and input 35 are coupled using one-half inch plastic tubing. In the embodiment shown, port 75 also functions as an inlet when receiving demineralized water 60 from purification system 80. In an alternative embodiment, a separate inlet(s) and a separate outlet(s) are used.

Apparatus 100 further includes a device 85 that provides a material (e.g., liquid) for adjusting the conductivity of demineralized water 60. By way of example, device 85 includes a filtration system for removing sediment and contaminants from water source 10 before water source 10 is supplied to purification system 80. Unlike purification system 80, filtration system 85 does not remove significant amounts of scale producing substances such as calcium, magnesium carbonates, bicarbonates or silica, and also has little effect on the conductivity of the filtered water. In one embodiment, filtration system 85 includes a series of filters, such as a sediment filter or filters 86 and carbon filter or filters 87. In the embodiment shown, the material or liquid used to control the conductivity of demineralized water 60 is filtered water 88.

Filtration system 85 further provides a source of filtered water to purification system 80 at inlet 83. A valve 84 is placed between filtration system 85 and purification system 80, which operates in response to a pressure switch 82. For example, when pressure switch 82 senses that tank 15 needs an additional amount of demineralized water 60, a signal is sent to open valve 84, which allows filtered water 88 to flow through purification system 80.

In one embodiment, filtration system 85 is coupled to ESG system 30 using a flow restrictor 37 and needle valve 38, which control the volume of flow of filtered water 88 from filtration system 85. Filtered water or material 88 is mixed with demineralized water 60 at a mixing device, stream joining device, tee apparatus or arrangement 39. In one embodiment, a sensor 41 is placed before inlet 35 to sense variations in total dissolved solids (TDS) in mixed water 8860 to control the opening and closing of a flow adjusting device, a device for adjusting flow, a device for controlling flow, or valve 44, which controls the conductivity of mixed water 8860 introduced to ESG system 30. In an alternate embodiment, sensor 41 comprises a conductivity sensor. In a further embodiment, sensor 41 comprises a resistivity sensor.

In one embodiment, apparatus 100 further includes a mixing vessel 43, which provides more volume to improve the mixing of filtered water 88 and demineralized water 60 prior to being introduced to ESG system 30. A check valve 61 provides isolation between purification system 80, tank 15 and filtration system 85 so that filtered water 88 cannot backfill or backflow into tank 15, purification system 80, and/or the associated connective plumbing.

In an alternative embodiment, ESG system 30 includes an internal vessel having separate inlets for coupling to purification system 80 and filtration system 85 so that the mixing of demineralized water 60 and filtered water 88 occurs within ESG system 30.

Apparatus 100 provides a controlled mixture 8860 of demineralized water 60 and filtered water 88 to ESG system 30. In addition, apparatus 100 minimizes the problems induced by either operating ESG system 30 on filtered water alone in which case the problems associated with mineral scaling would occur, or on demineralized water alone in which case ESG system 30 would fail to operate properly because the conductivity of the water supplied to it would be too low to sustain proper operation.

In accordance with the present invention, material or filtered water 88, which contains minerals from water source 10, is added in controlled amounts to demineralized water 60 in apparatus 100 to provide a sufficient or an increased conductivity to allow proper operation of ESG system 30. Because the volume of minerals in filtered water 88 is small compared to the overall volume of demineralized water 60, the amount of minerals added through filtered water 88 does not harm ESG system 30. Filtration system 85 does not remove significant amounts of minerals such as calcium, magnesium carbonates, sulphates, bicarbonates or silica or other scale producing substances. In one embodiment, the conductivity of mixture 8860 is maintained or controlled to be greater than about 100 micro-siemens/cm.

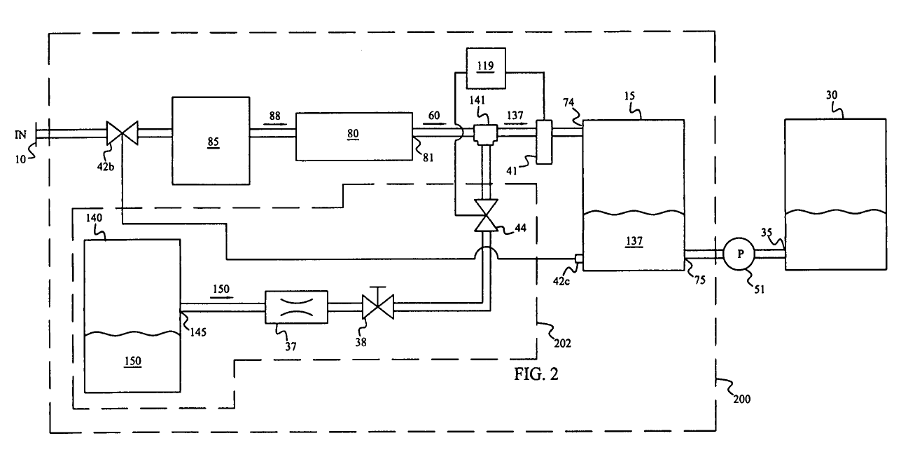

FIG. 2 shows a schematic view of an apparatus 200 for providing a source 137 of demineralized water having a controlled or optimized concentration of impurities or inorganic substances. In this embodiment, apparatus 200 provides a water source 137 having an optimized conductivity in accordance with another embodiment of the present invention. Like apparatus 100, apparatus 200 is shown coupled to an ESG system 30 where it is useful for, among other things, reducing scale effects. In an alternative embodiment, apparatus 200 is coupled to another system where water conductivity or inorganic impurity level control is relevant.

Apparatus 200 includes an inorganic impurity removing device, a water demineralization device or system, or purification system 80, which comprises for example, a reverse osmosis (R.O.) purification system, a de-ionizing (D.I.) purification system, combinations thereof, or the like. Purification system 80 provides a source of demineralized water 60 to storage vessel or tank 15 through an inlet or passage 74. In one embodiment, tank 15 comprises a plastic storage tank cleaned for pure water service. Tank 15 includes an outlet 75 that is coupled to an input 35 of ESG system 30. In one embodiment, a pump 51 is used to provide an increased pressure of tank contents 137 to ESG system 30. In a further embodiment, a level sensor 42c monitors the fluid level in tank 15 and is coupled to a valve 42b. For example, when level sensor 42c senses that tank 15 needs an additional amount of demineralized water 60, a signal is sent to open valve 42b, which allows water 10 to flow through filtration system 85 to purification system 80.

In accordance with the present invention, apparatus 200 further includes a conductivity control system or device for controlling conductivity 202, which comprises a tank 140 for holding a quantity of material or electrolyte 150 for adjusting the conductivity of demineralized water 60. Tank 140 has an outlet 145 that is coupled to a flow restrictor 37 and needle valve 38, which control the volume of flow of electrolyte 150 from tank 140. In one embodiment, outlet 145 and outlet 81 of purification system 80 are coupled using a tee fitting 141 to provide a mixed stream or mixture 137 of demineralized water 60 and electrolyte 150 to tank 15, which is then delivered to ESG system 30. Conductivity control system 202 further includes a sensor or conductivity sensor 41, which senses for example, the conductivity of mixture 137. Sensor 41 is coupled to a controller 119 that is further coupled to a flow adjusting device, a device for adjusting flow, a device for controlling flow, or valve 44. Controller 119 sends a signal to valve 44 to open or close it depending on the desired conductivity level of mixture 137.

In an alternative embodiment, ESG system 30 has an internal vessel having separate inlets for coupling to both outlet 81 and outlet 145 so that the mixing of demineralized water 60 and electrolyte 150 occurs within ESG system 30. In this embodiment, conductivity sensor 41 is placed in proximity to the internal vessel.

In accordance with one embodiment of the present invention, electrolyte 150 includes a suitable metal hydroxide. In one embodiment where apparatus 200 is coupled to an ESG system, the solubility of the metal hydroxide is selected for example, to be greater than about 40 grams per one-hundred cubic centimeters in demineralized water so that any deposits left are easily rinsed off with water. Furthermore, electrolyte 150 is added to demineralized water 60 to maintain the conductivity of mixture 137 greater than about 100 micro-siemens/cm.

By way of example, electrolyte 150 comprises sodium hydroxide, potassium hydroxide or the like. Metal hydroxides contain highly conductive ions, which significantly reduces the amount of electrolyte 150 required to be added to demineralized water 60 to raise the conductivity of mixture 137. This simplifies maintenance and storage requirements and reduces operation costs compared to systems that use salts such sodium chloride.

Also, metal hydroxide electrolyte materials function to raise the pH of mixture 137, which provides enhanced corrosion resistance compared to other materials such as sodium chloride. For example, using sodium chloride to raise the conductivity to a similar range as a metal hydroxide would result in a highly corrosive solution that would be detrimental to the metal surfaces of ESG system 30.

Additionally, traditional soft water systems use sodium chloride or other chlorides and they do not remove alkalinity. High alkalinity solutions further contribute significantly to detrimental scaling, as soft water systems exchange calcium and magnesium for sodium (salt). Furthermore, sodium is a very high scale producing material, and is known to reduce efficiency and longevity of ESG systems.

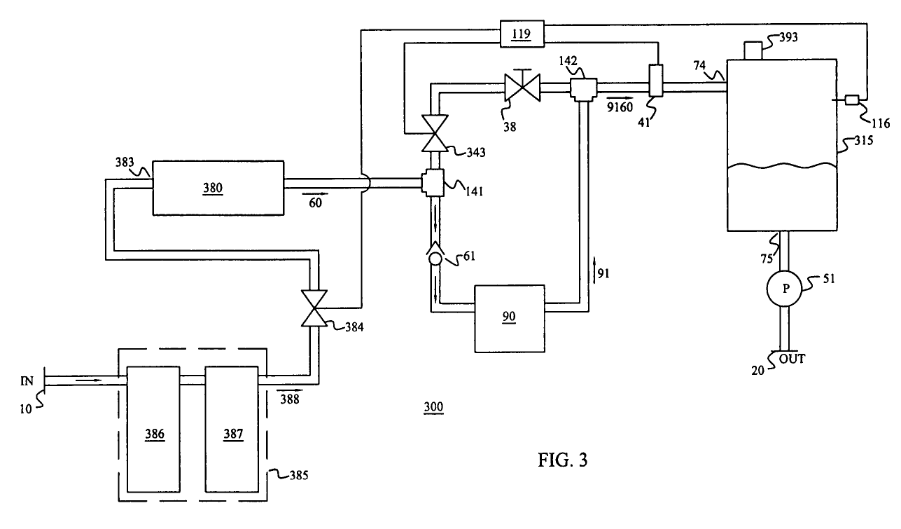

FIG. 3 shows a schematic view of an apparatus or system 300 for controlling the concentration of impurities or inorganics in a water stream 10 in accordance with another embodiment of the present invention. In one embodiment, apparatus 300 provides a water stream 9160 having an optimized or controlled conductivity. Apparatus 300 includes a first inorganic impurity removing device, first demineralization device or R.O. purification system 380, which provides a source of purified or demineralized water 60. In one embodiment, apparatus 300 further includes a filtration system 385 for removing sediment and contaminants from water source 10 before water source 10 is supplied to R.O. purification system 380. By way of example, filtration system 385 includes a series of filters, such as a sediment filter or filters 386 and carbon filter or filters 387. Filtration system 385 further provides a source of filtered water 388 to inlet 383 of R.O. purification system 380. A valve 384 is placed between filtration system 385 and R.O. purification system 380, which operates in response to a level control switch 116 located in a tank or storage vessel 315 and a signal sent from a controller 119. For example, when level control switch 116 senses that tank 315 needs an additional amount of demineralized water 60, a signal is sent from controller 119 to open valve 384, which allows filtered water 388 to flow to R.O. purification system 380.

Demineralized water 60 is then fed to a first stream splitting device or first tee 141. At first tee 141, all or a portion of demineralized water 60 is fed from one outlet of first tee 141 to an inlet to a second inorganic impurity removing device, a second demineralization device or system or D.I. purification system 90, which provides a source of deionized, demineralized, or further demineralized water 91. A check valve 61 can be used to prevent back flow occurrence.

In accordance with the present invention, a controlled portion of demineralized water 60 is split or separated at first tee 141 and mixed with deionized water 91 at a second tee, stream or fluid joining, or stream or fluid coupling device 142 to provide a mixed stream 9160 having an optimized, desired, or controlled conductivity. By way of example, the controlled portion is obtained by opening or closing a flow adjusting device, a device for adjusting flow, a device for controlling flow, or valve 343. A needle valve 38 controls the volume of flow of demineralized water 60 into second tee 142. In one embodiment, a conductivity probe 41 measures the conductivity of mixture 9160 after the streams are mixed at second tee 142, which is monitored by controller 119. Controller 119 sends a signal to valve 343, which is opened or closed to increase or decrease the amount of demineralized water 60 split at first tee 141 depending on the desired conductivity level of mixture 9160. Mixture 9160 is then fed to a tank or storage vessel 315 through an inlet 74. By way of example, mixture 9160 is then fed through an outlet 75 and pumped by a pump 51 to an output or point of use 20. In an optional embodiment, a bacteria filter 393 is coupled to tank 315 as shown in FIG. 3. By way of example, apparatus 300 provides a mixture 9160 having a conductivity on the order of about ten (10) to about twenty (20) micro-siemens/cm.

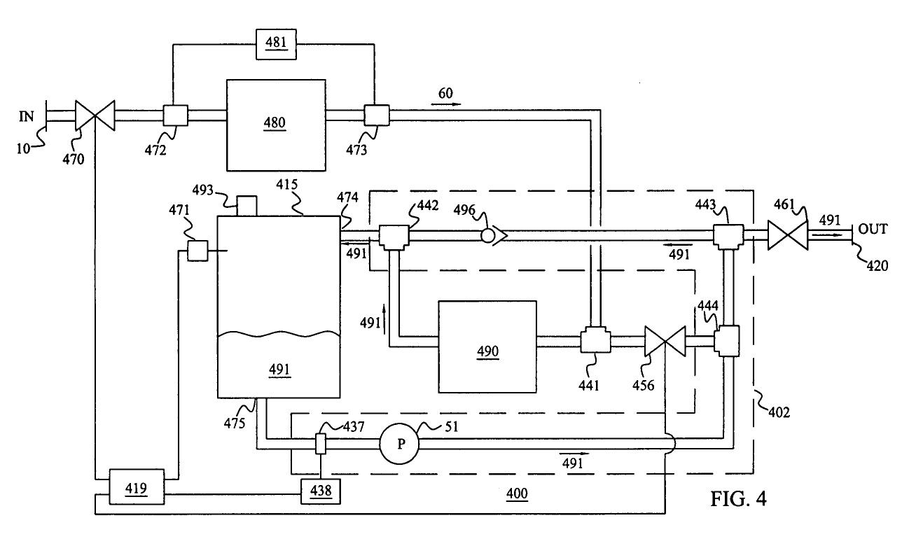

FIG. 4 shows a schematic view of an apparatus or system 400 for providing a water stream having a controlled concentration of minerals or inorganics in accordance with a still further embodiment of the present invention. In this embodiment, apparatus 400 provides a water stream 491 having a controlled or optimized resistivity at an output 420. In apparatus 400, a source of water 10 is fed through a first demineralization device or R.O. purification system 480, which provides a source of demineralized or purified water 60 to a first fluid splitting device or first tee 441. Demineralized water 60 is then fed to a second demineralization device or D.I. purification system 490, which provides a source of purified, demineralized, or further demineralized water 491. Demineralized water 491 is then fed through a fluid or stream joining device or second tee 442 and through an inlet 474 into a tank or storage vessel 415. In another embodiment, demineralized water 491 is fed directly into tank 415.

A fluid circuit 402 is coupled to an outlet 475 of tank 415 and is further coupled to inlet 474 and an outlet 420 for coupling apparatus or system 400 to another device. Demineralized water 491 exits tank 415 through outlet 475, and a pump 51 provides an increased pressure of demineralized water 491 through a fluid or stream splitting device or third tee 443, which exits apparatus 400 at a port or outlet 420. A valve or ball valve 461 is opened to allow demineralized water 491 to exit apparatus 400. When valve 461 is closed, demineralized water 491 in fluid circuit 402 is returned or recirculated to tank 415 through inlet 474. A check valve 496 ensures the proper flow of demineralized water 491 exiting D.I. purification unit 490 into tank 415 at inlet 474.

In accordance with the present invention, a probe or resistivity sensor 437 measures the concentration of impurities or resistivity of demineralized water 491 at outlet 475, which is monitored by a resistivity meter 438. Resistivity meter 438 is coupled to a flow adjusting device, a device for adjusting flow, a device for controlling flow, or valve 456 through a controller 419, which is opened or closed depending on the desired resistivity of demineralized water 491. By way of example, if the resistivity of demineralized water 491 drops below a desired level, controller 419 opens valve 456. Demineralized water 491 then passes through a stream splitting device or fourth tee 444, and is then sent through D.I. purification system 490 to remove further impurities and increase the resistivity of demineralized water 491 to a desired or preset value.

A level sensor 471 monitors the level of demineralized water 491 in tank 415, and is coupled to a valve 470 through controller 419. When the level in tank 415 drops below a desired level, valve 470 is opened to allow water 10 to flow through R.O. purification system 480. A conductivity meter 481 is coupled to conductivity sensors 472 and 473 to monitor the conductivity of water source 10 and demineralized water 60. In one embodiment, R.O. purification system 480 is set to achieve a 95% to 98% rejection rate. An optional bacteria air filter 493 is coupled to tank 415 as shown. By way of example, apparatus 400 provides a source of demineralized water 491 having a resistivity on the order of 1 megohms/cm.

By now it should be appreciated that there has been provided apparatus for providing a source of water having a controlled level of impurities or inorganics.

Although the invention has been described and illustrated with reference to specific embodiments thereof, it is not intended that the invention be limited to these illustrative embodiments. Those skilled in the art will recognize that modifications and variations can be made without departing from the spirit of the invention. Therefore, it is intended that this invention encompass all such variations and modifications as fall within the scope of the appended claims.

What is claimed is:

1. An apparatus for providing a water stream having a controlled level of impurities comprising:
a water demineralization system having an input and an output for providing a source of demineralized water;
a device that provides a material for adjusting the level of impurities in the demineralized water;
a mixing device coupled to the output of the water demineralization system and an output of the device; and
a flow adjusting device coupled to operate in response to a sensor for controlling an amount of material added to the demineralized water.

2. The apparatus of claim 1 wherein the device includes a water filtration system and wherein the material comprises filtered water.

3. The apparatus of the claim 1 wherein the device includes a storage vessel for storing the material, and wherein the material to be stored comprises an electrolyte.

4. The apparatus of claim 3 wherein the electrolyte includes a metal hydroxide.

5. The apparatus of claim 4 wherein the metal hydroxide comprises sodium hydroxide or potassium hydroxide.

6. The apparatus of claim 1 further including an electrode steam generator coupled to an output of the apparatus.

7. The apparatus of claim 1 further comprising a flow controller coupled to the output of the device to meter an amount of the material.

8. The apparatus of claim 1 wherein the apparatus provides a water stream having a conductivity greater than about one-hundred micro-siemens/cm when the apparatus is coupled to a source of water.

9. The apparatus of claim 1 further including a storage vessel for storing the demineralized water.

10. An apparatus for providing a demineralized water stream comprising:
a first demineralization device having an input and an ouput;
a stream splitting device coupled to the output of the first demineralization unit and further having first and second outputs;
a second demineralization device having an input coupled to the first output of the first stream splitting device, wherein the second demineralization device has an output;
a stream joining device having a first input coupled to the second output of the stream splitting device, a second input coupled to the output of the second demineralization device, and an output; and
a device for adjusting flow of demineralized water from the second output of the first stream splitting device, wherein the device for adjusting flow increases or decreases flow in response to a sensor placed at the output of the stream joining device.

11. The apparatus of claim 10 wherein the first demineralization device comprises a reverse osmosis system.

12. The apparatus of claim 10 wherein the second demineralization device comprises a deionization system.

13. The apparatus of claim 10 further comprising a filtration device coupled to in an input of the first demineralization device.

14. The apparatus of claim 10 further comprising a storage vessel coupled to the output of the first stream joining device.

15. The apparatus of claim 10 wherein the apparatus produces a demineralized water stream having a conductivity from about ten micro-siemens/cm to about twenty micro-siemens/cm when coupled to a source of water.

16. A system for producing a demineralized water stream comprising:
a first demineralization device having an output;
a second demineralization device having an input coupled to the output of the first demineralization device;
a storage vessel coupled to the second demineralization unit;
a fluid circuit coupled to an output of the storage vessel and coupled to the input of the storage vessel for recirculating the demineralized water;
a first stream splitting device coupled to the first fluid circuit and having an output coupled to the input of the second demineralization device; and
a device for controlling flow of demineralized water from the output of the first stream splitting device to the second demineralization device in response to a sensor placed in the fluid circuit to measure concentration of impurities in the demineralized water.

17. The system of claim 16 wherein the system provides a water stream having a controlled resistivity.

18. The system of claim 16 further comprising a pump to increase the pressure of demineralized water flowing in the fluid circuit when the system is coupled to a source of water.

19. The system of claim 16 wherein the first demineralization device comprises a reverse osmosis device.

20. The system of claim 16 wherein the second demineralization device comprises a deionization device.
